(19) United States
(12) Patent Application Publication
(10) Pub. No.: US 2012/0100382 A1
(43) Pub. Date: Apr. 26, 2012

(54) PROCESS FOR DEPOSITING A COATING ON METAL OR NON-METAL ITEMS, AND ITEM OBTAINED THEREFROM

(76) Inventors: Arturo Sabbioni, Trento (IT); Andrea Fabbri, Trento (IT)

(21) Appl. No.: 12/529,641

(22) PCT Filed: Jul. 7, 2009
(86) PCT No.: PCT/IB2009/052948

§ 371 Date: Sep. 2, 2009

(51) Int. Cl. B32B 15/01; B05D 3/12; B32B 3/26; B05D 1/02

(52) U.S. Cl. 428/457; 427/446; 428/304.4; 428/615

(57) ABSTRACT

A process for depositing coatings on metal or non-metal pieces includes phases of arranging at least a piece on which to deposit the surface coating, arranging at least a plasma torch, igniting the plasma torch and supplying the coating material to the plasma torch. An electric arc is established between the plasma torch and the piece during the coating deposit phase.

### TECHNICAL FIELD

The present invention relates to a process for depositing coatings on metal or non-metal items, and the item obtained with such process.

In particular, the present invention relates to a process for depositing very rough and porous coatings on endosseous prostheses.

### BACKGROUND ART

Endosseous prostheses, e.g., hip prostheses of the type not cemented on the bone, comprise metal parts on which are deposited coatings intended to be coupled directly with the bone tissue. In more detail, the surface of such coatings is typically distinguished by a certain roughness, in such a way that the bone cells can proliferate within such roughness so as to anchor the bone itself mechanically to the prosthesis. One of the technologies most commonly used to obtain the deposit of a layer of coating on the metal parts of the endosseous prostheses is that of the so-called “plasma spray” This process uses a plasma torch, of the non-transfer electric arc type, which is used as a means for melting and propelling the metal coating material, typically supplied in the form of powder and composed, e.g., of titanium.

By way of a short explanation, it must be pointed out that a non-transfer electric arc plasma torch comprises a nozzle, which acts as an anode, inside which a cathode is housed Through this nozzle, a gas mixture flows supplied with suitable pressure, comprising, e.g., argon, hydrogen, helium, nitrogen. A high-frequency electric pulse generates the first ionization of the gas. The passage of direct electric current between anode and cathode then maintains the plasma which, due to the high power reaches a very high temperature. Before the coating phase, a second power generator connecting the plasma torch and the piece to be coated, can generate an electric discharge, called transferred arc, which has the job of heating and cleaning the surface of the piece before the coating. Once the temperature or the required degree of cleaning has been achieved, the transferred arc generator is disabled and the actual coating phase can begin.

The particles of metal coating material, generated by the melting of the supplied powder granules, are dragged at high speed by the ionized gas mixture, and then projected onto the surface of the metal piece, where they are deposited. In more detail, the plasma spray technology has now achieved good levels of porosity—around 30%-60%, whereby porosity is the ratio between the volume of the pores and the total volume of the material. Nevertheless, the surface extension of such pores, which is normally below 100 micron, makes them rather unsuitable for accommodating the colonization of the bone cells. If the size of the pores of the plasma spray coatings could be increased, the growth of bone tissue that could be obtained inside the porosity of the coating could further upgrade the quality of the prosthesis-bone interface, and reduce the “stress shielding” problems associated with a non-gradual interface. The attempt to produce, using traditional Plasma Spray technology, coatings with larger porosity—around 200-1000 μm, generally gives rise to coatings with low mechanical properties and with an unacceptable loss of particles.

Another widespread technology consists of depositing, on the surface of the metal part of the endosseous prosthesis, sintered balls, e.g., made of titanium or other material. This technology permits having porosities of many hundreds of microns, thereby permitting the growth of bone tissue in the coating. The balls furthermore, being sintered, generally provide enough mechanical stability.

At the current state of the art, it has however been found that these and other known technologies for depositing coating layers produce results that are not adequate for prosthesis application requirements. The surfaces obtained are in fact porous, but not rough enough, and do not therefore provide enough primary stability. From a production viewpoint, furthermore, ball layer sintering methods have a number of drawbacks. The heat cycle in high-temperature vacuum, needed for the sintering process, is expensive, worsens the mechanical properties of the substrate and thus reduces, in particular, the resistance of the prosthesis to fatigue. Because of said heat cycle, the prosthesis has to undergo a new mechanical machining operation due to loss of the general tolerances. The mechanical re-machining makes such process even less attractive from an industrial viewpoint: besides producing additional costs, such re-machining is made difficult by the low workability of the material after the heat treatment. Said mechanical machining, requiring lubricants, can cause dangerous contaminations of the sintered porous layer, contaminations that are not always easy to eliminate and in serious contrast with the biomedical application in question.

### OBJECTS OF THE INVENTION

One object of the present invention is to upgrade the state of the art.

Another object of the present invention is to develop a process for depositing coatings on metal and non-metal pieces, in particular on endosseous prostheses, that allows making pieces with high surface roughness and with high porosity, as well as with extension and depth of pores suitable for allowing the growth and colonization of the cells of the bone in which the prosthesis is implanted.

A further object of the present invention is to make metal or non-metal pieces, in particular endosseous prostheses, that can be successfully coupled with the bone involved and suitable for reducing the known phenomena of “stress shielding” on the patient's bone, i.e., the aggregation of the bone cells in the most mechanically loaded areas.

Yet another object of the present invention is to present a process for depositing coatings on metal or non-metal pieces, in particular on endosseous prostheses that can be implemented in a simpler, more effective and less expensive way compared to that of ball layer sintering.

Another object of the present invention is to develop a process for depositing coatings on metal or non-metal pieces, in particular on endosseous prostheses that permits obtaining coatings that are mechanically more stable and more resistant than those obtainable with the known and traditional technologies, with simpler machining phases and reduced production costs.

In conformity with one aspect of the invention a process is provided for depositing coatings on metal or non-metal pieces.

In conformity with another aspect of the invention a metal or non-metal piece is provided.

The claims refer to preferred and advantageous embodiments of the invention.

### BRIEF DESCRIPTION OF DRAWINGS

Other characteristics and advantages of the invention will be made more evident by the description of the embodiments of the process for depositing coatings on metal or non-metal pieces, and of the piece obtained by means of this process, illustrated by way of example on the attached drawings in which:

FIG. 1 is a schematic view of a detail of the system for implementing the process according to the invention;

FIG. 2 is a perspective view of an endosseous prosthesis made with the process according to the invention;

FIG. 3 is a schematic view of an alternative embodiment of the endosseous prosthesis made using the process according to the invention;

FIG. 4 is a perspective microscope enlargement of the surface coating of the endosseous prosthesis in FIG. 2;

FIG. 5 is a metallographic section under the microscope of a surface coating of an endosseous prosthesis made according to the known so-called “air plasma spray” method, i.e., plasma spray in the presence of air;

FIG. 6 is a metallographic section under the microscope of a surface coating of an endosseous prosthesis made according to the known so-called “vacuum plasma spray” method, i.e., plasma spray under vacuum;

FIG. 7 is a metallographic section under the microscope of a surface coating of an endosseous prosthesis made using the process according to the invention;

FIG. 8 is a perspective view of a further embodiment of the endosseous prosthesis made using the process according to the invention.

### DETAILED DESCRIPTION OF PREFERRED EMBODIMENTS

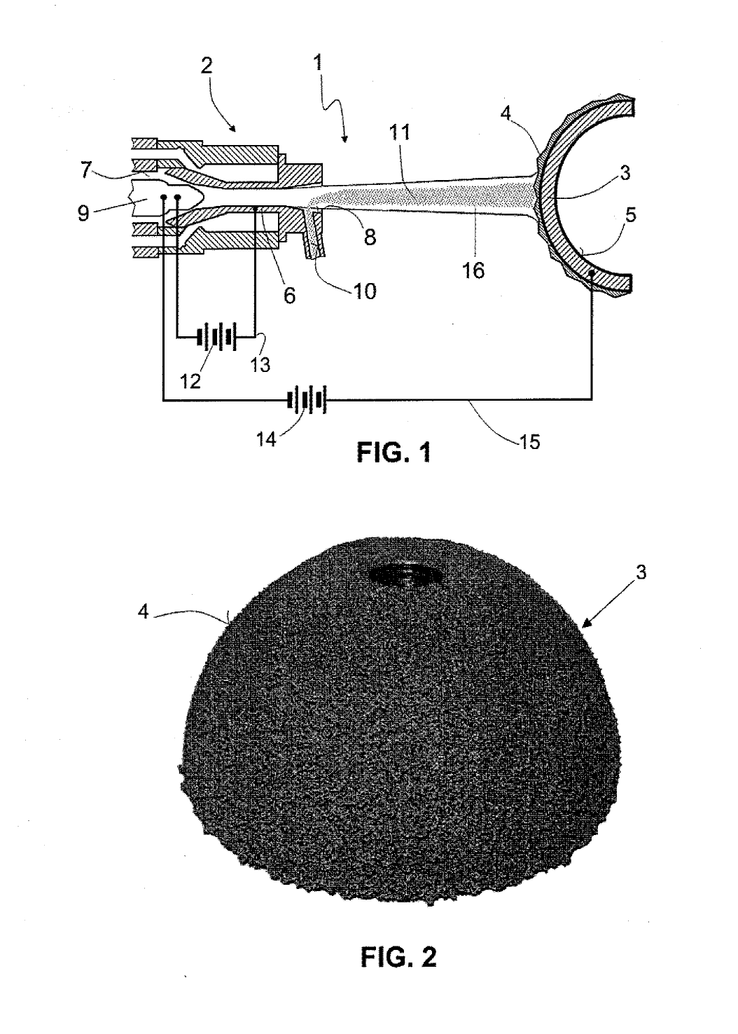

With particular reference to the FIG. 1, and in order to better understand the process according to the present invention, generally indicated by the number 1 is a part of the system for implementing the process for depositing a surface coating on metal or non-metal pieces according to the invention. The system 1 comprises at least a plasma torch, generally indicated by 2, associated with operating parts and control and supply means not shown in the illustration, but of substantially traditional type.

The operating parts ensure the movement of the plasma torch, while the control and supply means controls its operation according to the preset programs and provide the necessary power and gas mixture supply, as better described below.

The plasma torch 2 is positioned in front of a piece 3, e.g., a metal piece 3, on which a surface coating 4 is to be deposited; the metal piece 3 is mounted on a respective support, not shown in the figures. Obviously, on the same support, numerous metal or non-metal pieces 3 can be mounted, identical or also different, whenever this permits cutting work times and costs. In the specific embodiment to which the present invention refers, and including but not limited to, the metal piece 3 on which the surface coating has to be deposited is composed of an endosseous prosthesis, in particular one of the components of a hip prosthesis. Such component can be made, e.g., in the shape of a hemispheric cap, and made, e.g., of a titanium metal alloy. The component defines a concave inner surface 5 for coupling either with a truncated-cone insert (also called wear insert) or directly with the head of the thigh bone prosthesis, or directly with the head of the thigh bone itself; on its outer convex surface—or substrate. On the other hand, the deposit is envisaged for a surface coating layer 4, of suitable roughness and porosity, suitable for interfacing with the bone tissue of the acetabular cup of the joint, into which it is permanently implanted.

The plasma torch 2 comprises, in a known way, a metal nozzle which internally defines a chamber 7, culminating with an orifice 8 facing the metal piece 3: inside the chamber 7 an electrode 9 is housed.

The chamber 7 is supplied with a gas mixture, comprising, e.g., argon, hydrogen, helium and nitrogen in suitable percentages, introduced with opportune pressure.

The nozzle 6 also defines one or more ducts 10, along which the metal material 11 is supplied, e.g., in the form of powder with grains of suitable size, to make the coating layer 4. This metal material 11 can be composed e.g. of titanium, but also of other material with suitable characteristics. In an embodiment of the process, this material can be composed e.g. of Ti6Al4V, i.e., titanium, aluminum and vanadium alloy.

A first power generator 12 places, by means of first connections 13, the electrode 9 in connection with the nozzle 6 so that between them, upon the flow of the gas mixture, a first electric arc can be established, as better explained later on. A second power generator 14 places, by means of second connections 15, the electrode 9 in connection with the metal piece 3 on which to deposit the surface coating 4, so that a second electric arc can be established between them as better explained later on.

In another embodiment, an electric circuit can be provided that permits supplying current between the electrode 9 and the nozzle 6 and between the electrode 9 and the metal piece 3 respectively, including at different times and by means of a single generator.

According to the invention, the process for depositing a surface coating 4 on a metal piece 3, e.g., an endosseous prosthesis, comprises a phase in which the above piece is previously arranged and prepared for machining: in particular, the metal piece 3 is mounted on a special support. On the same support, several metal or non-metal pieces 3 can be mounted, identical or also different.

The process then comprises a phase of arrangement of at least a plasma torch 2; as shown schematically in the FIG. 1, in a non-limitative way, the plasma torch 2 is positioned substantially in front of the metal piece 3, at a suitably defined distance.

The process also comprises a phase in which a vacuum is created in the environment in which the torch 2 and the metal piece 3 are arranged.

Whenever so requested by the application, at least a preparatory cleaning phase can be provided of the substrate on which the surface coating 4 is to be applied, by means of the establishment of an electric arc between the plasma torch 2 and the metal piece 3.

This is followed by a phase of supply of the plasma torch 2 with a suitable flow of the above gas mixture. The supply of such gas mixture is through the chamber 7, so the mixture is forced to exit from the orifice 8. The process further comprises a phase of power supply of the plasma torch 2 by means of the first generator 12, with suitable voltage, in such a way that, upon the flow of the gas mixture, a first high-amp electric arc can be established between the electrode 9 and the nozzle 6. This causes the gas mixture to heat up to ionization temperature, so as to generate a plasma, indicated schematically by 16. Furthermore, a preparatory heating phase of the above substrate can also be provided to favor the adhesion of the metal particles which then have to be deposited. Afterwards, the process comprises a supply phase of the coating material 11 at the nozzle 6 of the plasma torch 2, along the pipes 10. The material 11, supplied, for example, in the form of powder, melts on coming into contact with the plasma 16 and is conveyed onto the metal piece 3 by the plasma itself, depositing on the surface of the piece.

The process further comprises a phase of power supply of the plasma torch 2 by means of the second generator 14, with suitable voltage, in such a way that, upon the flow of the gas mixture, a second high-amp electric arc can be established between the electrode 9 and the metal piece 3. This allows transferring a further quantity of energy from the plasma to the coating, during the formation of the coating itself. Electric micro-discharges of around 100 ampere are in fact generated between the torch 2 and the piece 3, which permit obtaining a greater concentration of energy on the coating and the sintering of the powder particles on the piece 3 itself. This creates a surface coating 4 with innovative characteristics which will be described in detail below. In particular, said sintering phenomenon occurs in conditions very different to those of thermodynamic equilibrium, as is the case instead with heat cycles inside the furnace. In this way, very high energy densities can be obtained for fractions of a second, which allow localized sintering phenomena without heating the whole prosthesis to the sintering temperature itself.

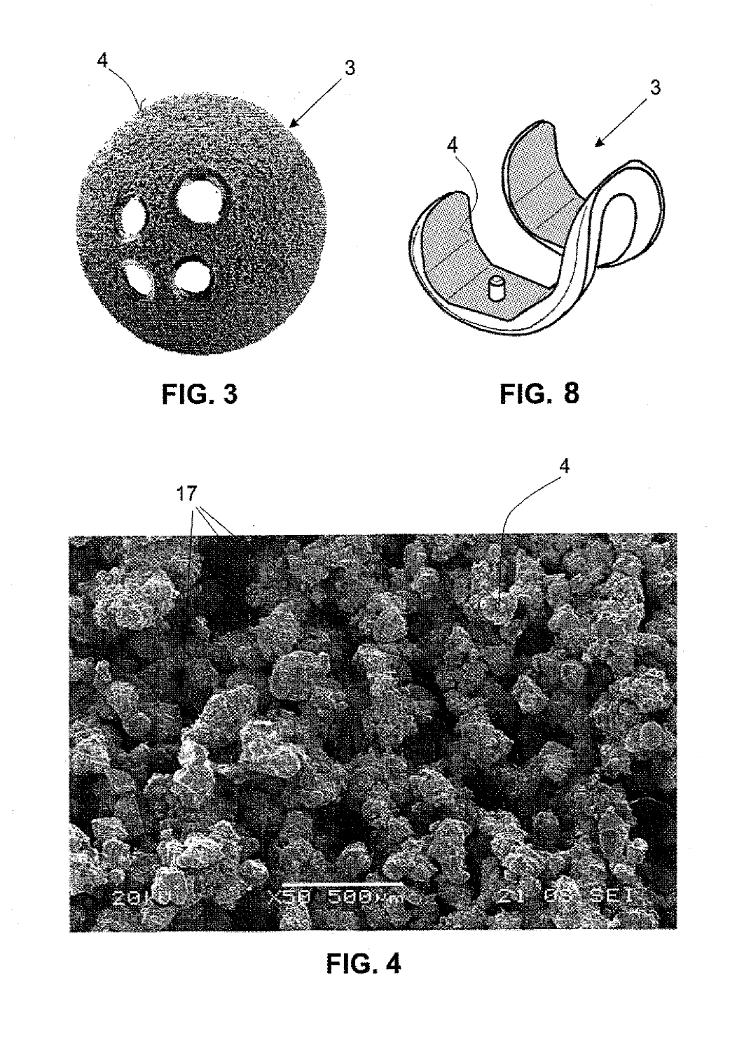

Finally, at least a finishing phase is envisaged of the surface coating 4 by means of titanium shot-peening. FIGS. 2 and 3 each show, by way of non-limitative example, a metal piece 3 with a surface coating 4 obtained with the process according to the invention. Such metal piece is composed in particular of an endosseous prosthesis, with a surface suitable for being implanted in the bone.

FIG. 8 on the other hand shows, by way of a non-limitative example, a further alternative embodiment of an endosseous prosthesis obtained with the process according to the invention. The FIG. 8 represents, in particular, a metal piece 3 composed of a thigh-bone prosthesis for a knee having a surface coating 4, made by means of the process according to the invention, at the surface suitable for interfacing itself with the bone tissue, i.e., with the thigh-bone tissue.

The metal piece 3 obtained with the process comprises a surface coating 4 first of all distinguished by decidedly large thickness compared to those obtainable using traditional technologies, i.e., generally between 900 μm and 2000 μm.

A further important feature of the surface coating 4 obtainable with the process according to the present invention exists in the fact that such coating is mechanically more stable and stronger compared to those obtainable using traditional technologies, in particular, thanks to the effect of the application of an electric arc during the coating deposit phase. Furthermore, the surface coating 4 is distinguished by high roughness and porosity: the latter in particular is between 30% and 70%, as can be seen in the enlargement of FIG. 4.

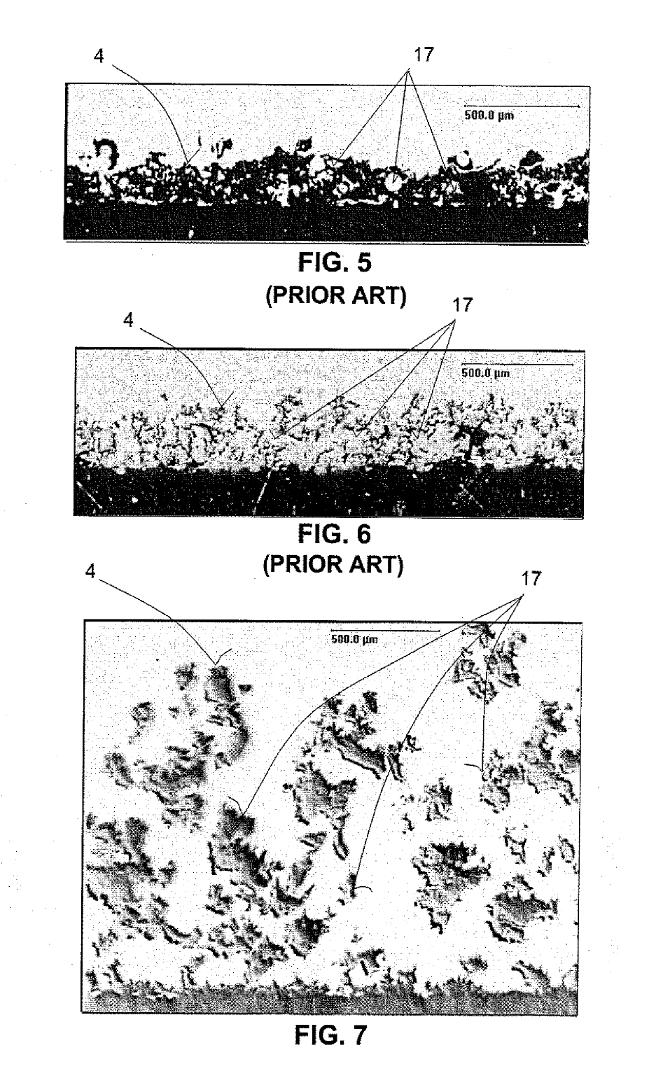

With particular reference to the metallographic section of the FIG. 7, the pores made on the surface coating 4, indicated by the reference number 17, generally have a depth between 100 μm and 1000 μm, and more in particular between 200 μm and 800 μm. Such depth is much greater than that—obtainable with traditional deposit technologies, to which refer, e.g., the metallographic sections of the FIGS. 5 and 6. In particular, the metallographic section under the microscope of FIG. 5 relates to a surface coating of an endosseous prosthesis made according to the so-called known “air plasma spray” method, i.e., plasma spray in the presence of air. The metallographic section under the microscope of FIG. 6 relates on the other hand to a surface coating of an endosseous prosthesis made according to the so-called known “vacuum plasma spray” method, i.e., plasma spray under vacuum.

Furthermore, as can always be seen in the FIGS. 4 and 7, the above pores 17 of the surface coating 4 have a surface extension generally between 100 μm and 500 μm, definitely much higher than that obtainable using traditional technologies.

Such morphological characteristics of the pores 17 enable, the endosseous prosthesis to be implanted in the patient, to much more extensively colonize the bone cells within them, with the result that the mechanical coupling between the bone and the prosthesis has considerably higher quality, resistance and duration characteristics than those relating to traditional prostheses, due to the fact that it extends over a very extensive porous surface.

The process to which the present invention refers can be applied, without any limitation whatsoever, to metal or non-metal pieces of any size and intended for any use whatsoever, and in particular in the applications in which a surface coating with high stability and mechanical strength, as well as very high roughness and porosity has to be realized on the piece, and in which very high pore dimensions—depth and surface extension—are required.

The present invention has been described according to preferred embodiments, but equivalent variations can be conceived without exiting from the protection ambit offered by the claims.

1. Process for depositing coatings on metal and non metal pieces, comprising the following phases:
arranging at least a piece on which to deposit a surface coating;
arranging at least a plasma torch;
igniting said plasma torch;
supplying a coating material to said plasma torch;
establishing an electric arc between said plasma torch and said piece during the supplying a coating deposit material phase.

2. Process according to the claim 1, comprising at least a phase of establishment of an electric arc between the electrode and the nozzle of said plasma torch.

3. Process according to claim 1, comprising at least a preparatory phase for the heating of the substrate of said piece.

4. Process according to claim 1, comprising at least a finishing phase of said coating surface by means of shot-peening.

5. Process according to the claim 4, in which said finishing phase of said coating surface is made by means of shot-peening with powder or with grits or with powder of the same material as the coating.

6. Process according to claim 1, comprising a phase of creating the vacuum in the environment in which said plasma torch and said piece are arranged.

7. Process according to claim 1, in which said piece comprises at least a surface coating with porosity between 30% and 70%.

8. Process according to claim 1, in which said piece comprises at least a surface coating comprising pores with depth between 100 μm and 1000 μm.

9. Process according to the claim 8, in which said surface coating comprises pores with depth between 200 μm and 800 μm.

10. Process according to claim 1, in which said piece comprises at least a surface coating comprising pores with surface extension between 100 μm and 500 μm.

11. Process according to claim 1, in which said piece comprises at least a surface coating with thickness between 900 μm and 2000 μm.

12. Process according to claim 1, in which said surface coating material is composed of titanium alloys, including at least one of titanium, aluminum and vanadium alloys.

13. Process according to claim 1, in which said piece comprises at least an endosseous prosthesis.

14. Metal or non-metal piece, wherein the piece comprises at least a surface coating with porosity between 30% and 70%.

15. Metal or non-metal piece according to the claim 14, in which said surface coating comprises pores with depth between 100 μm and 1000 μm.

16. Metal or non-metal piece according to the claim 15, in which said surface coating comprises pores with depth between 200 μm and 800 μm.

17. Metal or non-metal piece according to claim 14, in which said surface coating comprises pores with surface extension between 100 μm and 500 μm.

18. Metal or non-metal piece according to claim 17, in which said surface coating comprises pores with a surface extension between 300 μm and 400 μm.

19. Metal or non-metal piece according to claim 14, in which said surface coating has a thickness between 900 μm and 2000 μm.

20. Metal or non-metal piece according to claim 14, in which said coating material is composed of a titanium alloy.

21. Metal or non-metal piece according to claim 14, comprising at least an endosseous prosthesis.

22. Metal or non-metal piece, wherein the piece is obtained by according to the process of claim 1.
